(19) United States
(12) Patent Application Publication
(10) Pub. No.: US 2019/0099025 A1
(43) Pub. Date: Apr. 4, 2019

(54) COMBINATION FLEXIBLE DRINKING STRAW AND WHISTLE

(71) Applicant: Harry P Rieger, Orange, CA (US)

(72) Inventor: Harry P Rieger, Orange, CA (US)

(21) Appl. No.: 15/722,471

(22) Filed: Oct. 2, 2017

(51) Int. Cl. A47G 21/18

(52) U.S. Cl. CPC A47G 21/182; G10K 5/00

(57) ABSTRACT

Disclosed is a reusable combination corrugated drinking straw and whistle. The drinking straw has an elongated tubular body with a fluid passage running therethrough. The tubular body is manufactured from metal (e.g., stainless steel) and has a plurality of corrugations extending radially outward therefrom. The tubular body is flexible and adapted to be bent so as to enable a user of the corrugated drinking straw to sip a beverage from a cup or the like. The corrugated drinking straw can also be used to produce an audible whistling sound when it is removed from the cup. The whistling sound is achieved when the user blows his breath against a blowing end of the drinking straw that is cut through one of the corrugations that extends radially outward from the tubular body. In this case, the corrugated drinking straw is wider at its blowing end than at the tubular body thereof.

### BACKGROUND OF THE INVENTION

### 1. Field of the Invention

This invention relates to a reusable drinking straw of the kind used to drink a beverage from a beverage container and having a flexible tubular body that is manufactured from metal and includes a plurality of corrugations formed therein and extending continuously therealong. The corrugated drinking straw also has a relatively wide (e.g., flared) blowing end that is capable of generating an audible whistling sound when the user blows his breath at an angle towards the wide blowing end.

### 2. Background Art

Plastic drinking straws have long been used to sip a beverage from a glass or a bottle. Some drinking straws have a number of corrugations at which each straw can be bent to facilitate the straw being conveniently positioned between the beverage container and the mouth of a user. However, such conventional plastic drinking straws are typically subject to a single use only. That is, once the straws have been used, they are usually discarded and then must be replaced by new straws. With the significant number that are used on a daily basis, having to dispose of all of the single use straws results in a waste of resources. What is more, the discarded plastic straws commonly wind up in landfills where they are slow to degrade.

Accordingly, what would be desirable is an improved reusable straw that has the advantages of the conventional corrugated plastic straw but which need not be discarded after a single use and sent to a landfill where it and numerous other discarded single use straws will be collected in a landfill.

### SUMMARY OF THE INVENTION

In general terms, a corrugated drinking straw is disclosed of the kind that is used to sip a beverage from a cup, a bottle or a similar beverage container. The straw has a flexible tubular body that surrounds a fluid passage through which the beverage is removed from the container and drawn into the mouth of the user. The tubular body of the straw is manufactured from metal (e.g., stainless steel). A plurality of corrugations extend outwardly from and surround the tubular body along the length thereof. The flexible tubular body is responsive to a bending force so that the straw can be conveniently bent in different directions and positioned between the beverage container and the mouth of the user. The corrugated metallic straw of this invention may be reused a number of times to avoid its having to be discarded after a single use and replaced by a new straw.

The corrugated metallic drinking straw can also be advantageously used to generate an audible whistling sound when it is removed from the beverage container. To achieve the whistling sound, a blowing end of the straw runs through the first and/or the last of the corrugations that extend outwardly from and surround the tubular body. Therefore, the corrugated straw is wider at its blowing end then at its tubular body. The whistling sound is generated when the user blows his breath towards the blowing end of the straw.

### BRIEF DESCRIPTION OF THE DRAWINGS

FIG. 1 shows a combination corrugated drinking straw and whistle according to a preferred embodiment of this invention;

FIG. 2 is a cross-section of the drinking straw taken along lines 2-2 of FIG. 1; and

FIG. 3 shows the drinking straw of FIG. 1 bent and having one end thereof located in a beverage container from which a beverage can be sipped.

### DESCRIPTION OF THE PREFERRED EMBODIMENT

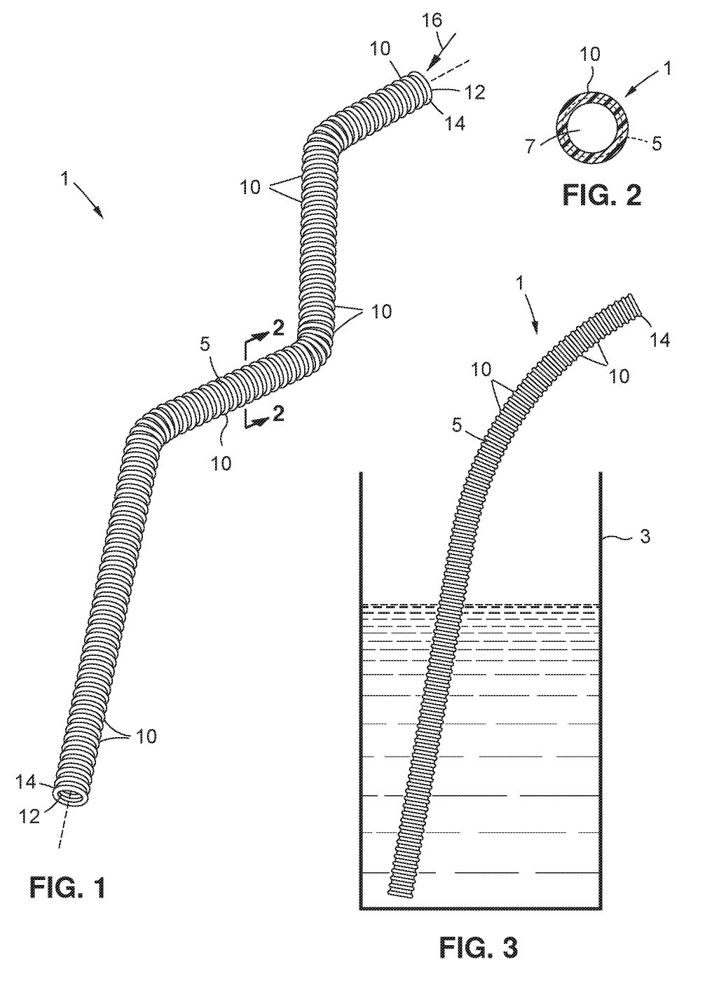

Referring concurrently to FIGS. 1-3 of the drawings, there is shown a corrugated eco-friendly drinking straw 1 of the kind to be located in a drinking cup 3 of FIG. 3 or pushed downwardly through the neck of a bottle (not shown) by which a beverage can be sipped by a user of the straw. As in the case of a traditional plastic drinking straw, the corrugated straw 1 described herein has an elongated tubular body which surrounds a fluid passage (designated 7 in FIG. 2) to which a suction force is applied at one end of the straw 1 in order to draw fluid from the cup 3 into the mouth of the user via the fluid passage 7. The particular length of the corrugated straw 1 and the diameter of the fluid passage 7 through the tubular body 5 thereof are not to be considered as limitations of this invention and may be selected to suit the needs of the user.

However, unlike the conventional plastic drinking straw, the corrugated straw 1 shown in FIGS. 1-3 is manufactured from metal. By way of a preferred example, the metal from which the straw is manufactured is 304 stainless steel. Thus, it may be appreciated that the corrugated eco-friendly straw 1 may be cleaned and reused many times so as to avoid the traditional one-time use, disposal and waste that are common to conventional plastic straws. In this same regard, the number of used and discarded straws can be greatly reduced over time so as to correspondingly reduce the number of discarded plastic straws that wind up in landfills.

The tubular body 5 of the corrugated straw 1 has a wall thickness (e.g., 1.0-3.0 mm) which enables it to be flexible and bend when a beverage is to be sipped from the cup 3. The straw 1 includes a plurality of spaced, parallel aligned corrugations 10 that extend radially outwardly therefrom so as to surround the tubular body 5 along its entire length. As shown in FIG. 1, the corrugated body 5 can be bent to form successive straw sections which turn and remain turned in different directions.

As a unique advantage of the corrugated straw 1 herein disclosed, it has been found that the straw is capable of functioning as a whistle. In particular, the straw will make an audible whistling sound when it is removed from the cup 3 and the user blows into one end 12 of the straw 1. The whistling sound is achieved by manufacturing (e.g., machining) one or both ends of the straw 1 with a cut through the first and/or the last of the corrugations 10 that are spaced from one another along the tubular straw body 5.

Thus, as is best shown in FIG. 1, each of the opposite blowing ends 12 of the straw 1 will be surrounded by at least some of a radially outward extending corrugation to create a relatively wide or flared peripheral lip 14. Each wide peripheral lip 14 is smoothed and flattened. It may therefore be appreciated that the corrugated straw 1 is wider at the relatively wide peripheral lips 14 that surround the blowing ends 12 than at the tubular body 5. In this regard, the user's breath is directed from about an inch away towards one blowing end 12 of the corrugated straw 1 at an angle (designated 16 in FIG. 1) relative to the longitudinal axis of the tubular body 5. The user may also surround the blowing end 12 with his lips and blow straight down into the straw 1. The user blowing against the relatively wide peripheral lip 14 causes a high pitch whistle to be emitted from the straw 1. The whistle can be generated in the manner just described for fun or to enable the user to call attention to himself in a noisy room. It has been found that the ability of the user to generate the audible whistle is increased when the flexible corrugated straw 1 is bent to receive the user's breath at the blowing end 12.

1.-7. (canceled)

8. A reusable drinking straw comprising an elongated tubular body that surrounds a fluid passage through which a fluid can be drawn to the mouth of a user, said tubular body having first and opposite ends and being manufactured from metal so as to be flexible and capable of being bent, said drinking straw being surrounded by a plurality of spaced corrugations that extend radially outward from and extend continuously along the entire length of said tubular body from the first end thereof to the opposite end, and wherein said first and opposite ends are surrounded by smooth and flat peripheral lips that have a width which is wider than the width of said tubular body, said peripheral lips being cut through the first one and the last one of said plurality of corrugations that are located at and surround respective ones of the first and opposite ends of said tubular body.
